(19) United States
(12) Patent Application Publication
(10) Pub. No.: US 2009/0236151 A1
(43) Pub. Date: Sep. 24, 2009

(54) Touch Panel Device

(76) Inventors: I-Hau YEH, Hsin-Chu (TW); Ji-Shien TENG, Hsin-Chu (TW)

Correspondence Address: Portal IPR Office;Chun-Ming Shih, P.O. box 223205, Chantilly, VA, 20153, US

(21) Appl. No.: 12/400,797

(22) Filed: Mar. 10, 2009

(30) Foreign Application Priority Data
Mar. 21, 2008 (TW) 097110182

(51) Int. Cl. G08C 21/00

(52) U.S. Cl. 178/18.03

(57) ABSTRACT

An exemplary touch panel device includes a substrate, an insulating layer form on a surface of the substrate, a plurality of first electrode groups and a plurality of second electrode groups. Each first electrode group includes a plurality of first electrodes and a plurality of first connecting wires each electrically connecting two adjacent first electrodes. Each second electrode group includes a plurality of second electrodes and a plurality of bridge connecting wires each electrically connecting two adjacent second electrodes. The first electrode groups and the second electrodes of the second electrode groups are alternately formed on a surface of the insulating layer away from the substrate. The bridge connecting wires are formed on the surface of the substrate contacting with the insulating layer.

### CROSS-REFERENCE TO RELATED APPLICATIONS

This application is based upon and claims the benefit of priority from the prior Taiwanese Patent Application No. 097110182, filed Mar. 21, 2008, the entire contents of which are incorporated herein by reference.

### BACKGROUND

1. Technical Field

The present invention is related to a touch panel device, and particularly to a capacitive touch panel device.

2. Description of the Related Art

In daily life, touch panels are widely used in all kinds of electronic products, such as cash machines of financial organ, guide information systems of department store, personal digital assistants (PDA), and notebooks. Generally, the touch panels are classified as resistive touch panels, capacitive touch panels, acoustic wave touch panels and optical touch panels according to their sensing principle wherein the resistive touch panel is the most extensively used touch panel with the lowest price among all, but the capacitive touch panel gains increasingly attention and popularity now.

Referring to FIG. 1, a structure of a typical capacitive touch panel device is shown. The capacitive touch panel includes a flat substrate 11, a first electrode unit 12 formed on a top surface of the flat substrate 11 and a second electrode unit 13 formed on a bottom surface of the flat substrate 11. A first conducting line 14 is formed on periphery area of the top surface of the flat substrate 11 and extended toward inside to electrically connect with the first electrode unit 12. A second conducting line 15 is formed on periphery area of the bottom surface of the flat substrate 11 and extended toward inside to electrically connect with the second electrode unit 13. A first extending wire and a second extending wire 16 and 17 are respectively electrically connected with the first and second conducting lines 14 and 15 for receiving power source or controlling signal.

When the power source or the controlling signal is provided to the first and second electrode units 12 and 13 via the first and second extending wires 16 and 17 and the first and second conducting lines 14 and 15, an electric field is formed around the flat substrate 11. When a finger of a user or a conductor is contacted or closed to the capacitive touch panel device, the electric field between the first and second electrode units 12 and 13 is correspondingly changed. Accordingly, a capacity at a touch point is changed. Thus the capacitive touch panel device can detect coordinates of the touch point according to the changes.

In a manufacturing process of the capacitive touch panel device, the first and second extending wires 16 and 17 are respectively formed on the periphery areas of the top and bottom surfaces of the flat substrate 11 via bonding wire for respectively connecting to the first and second conducting lines 14 and 15. Thus the first and second extending wires 16 and 17 can electrically connected to the first and second electrodes units 12 and 13 via the first and second conducting lines 14 and 15. However, when the first and second extending wires 16 and 17 extend outside the periphery area of the flat substrate 11, a variable interval between the first extending wire 16 and the second extending wire 17 results in an interference signal therebetween. The interference signal can interfere with the detecting of the coordinates of the touch point, and decrease a yield rate of the capacitive touch panel device.

What is needed, therefore, is a touch panel device which is capable to overcome the above described problem.

### BRIEF SUMMARY

Embodiments of the present invention provide a touch panel device having simple structure and being manufactured easily.

Embodiments of the present invention also provide a touch panel device having simple structure, and the electronic-magnetic interference comes from outside of the touch panel device can be reduced.

One embodiment of the present invention provides a touch panel device. The touch panel device includes a substrate, an insulating layer form on a surface of the substrate, a plurality of first electrode groups and a plurality of second electrode groups. Each first electrode group includes a plurality of first electrodes and a plurality of first connecting wires each electrically connecting two adjacent first electrodes. Each second electrode group includes a plurality of second electrodes and a plurality of bridge connecting wires each electrically connecting two adjacent second electrodes. The first electrode groups and the second electrodes of the second electrode groups are alternately formed on a surface of the insulating layer away from the substrate. The bridge connecting wires are formed on the surface of the substrate contacting with the insulating layer.

Another embodiment of the present invention provides a touch panel device, which comprises a transparent substrate, a transparent insulating layer and a sensing unit. The transparent insulating layer is formed on a surface of the substrate. The sensing unit comprises a plurality of first electrode groups and a plurality of second electrode groups, wherein each second electrode group comprises a plurality of electrodes and a bridge connecting wires electrically connecting two adjacent electrodes. The first electrode groups and the electrodes of the second electrode groups are alternately formed on a surface of the insulating layer to define a sensing plane corporately, the bridge connecting wires are formed between the substrate and the sensing plane.

The touch panel device has some advantages. For example, the sensitivity of the touch panel device is improved because the first electrode groups and the electrodes of the second electrode groups are nearer to the touch surface, and the uniformity of the sensitivity is improved because the first electrode groups and the electrodes of the second electrode groups are formed on the same surface. Moreover, the structure is much simpler than some other touch panels. Furthermore, by forming the insulating layer, the first and second electrode groups are farther away from other modules (such as Liquid Crystal Display Module, LCM) such that the electronic-magnetic interference from these modules can be reduced. In another aspect, as the bridge connecting wires are covered by the insulating layer and the insulating layer can be polished to form a flat plane, the first electrode groups and the electrodes of the second electrode groups can be easily formed on the surface of the insulating layer.

Other objectives, features and advantages of the touch panel device will be further understood from the further technological features disclosed by the embodiments of touch panel device wherein there are shown and described preferred embodiments of this touch panel device, simply by way of illustration of modes best suited to carry out the present invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of a conventional touch panel device.

FIG. 2 is a cross-sectional view of a touch panel device according to a first embodiment.

FIG. 3 is a schematic vertical view of the touch panel device of FIG. 2.

FIG. 4 is a schematic, exploded view of the touch panel device of FIG. 2.

FIG. 5 is a schematic, exploded view of the touch panel device according to a second embodiment.

FIG. 6 is a schematic vertical view of the touch panel device of FIG. 5.

FIG. 7 is a cross-sectional view of the touch panel device of FIG. 5.

FIG. 8 is an enlarged view of the part A in FIG. 7.

FIG. 9 is a cross-sectional view of a touch panel device according to a third embodiment.

FIG. 10 is a enlarged view of the part B in FIG. 9.

FIG. 11 is a cross-sectional view of a touch panel device according to a fourth embodiment.

FIG. 12 is a cross-sectional view of a touch panel device according to a fifth embodiment.

FIG. 13 is a cross-sectional view of a touch panel device according to a sixth embodiment.

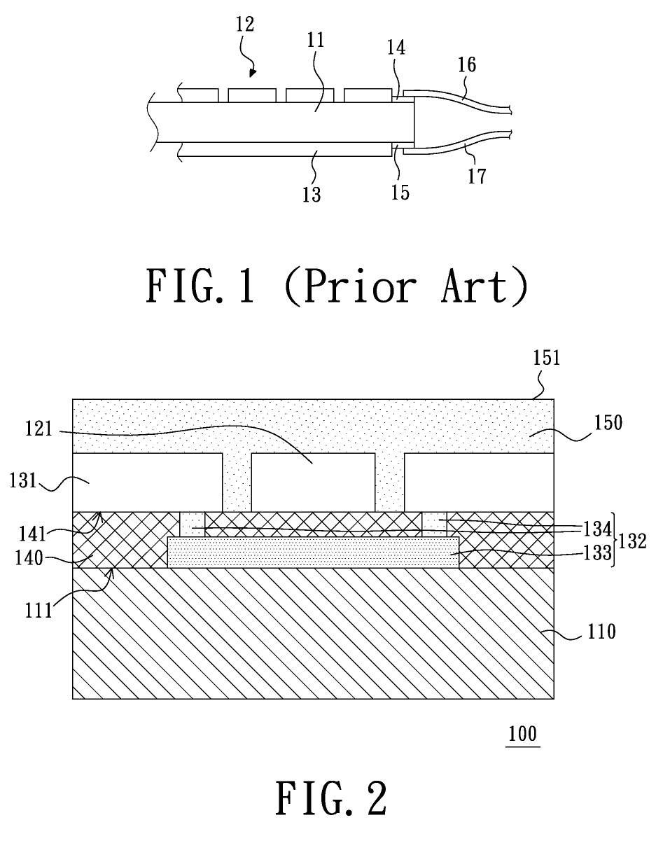

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

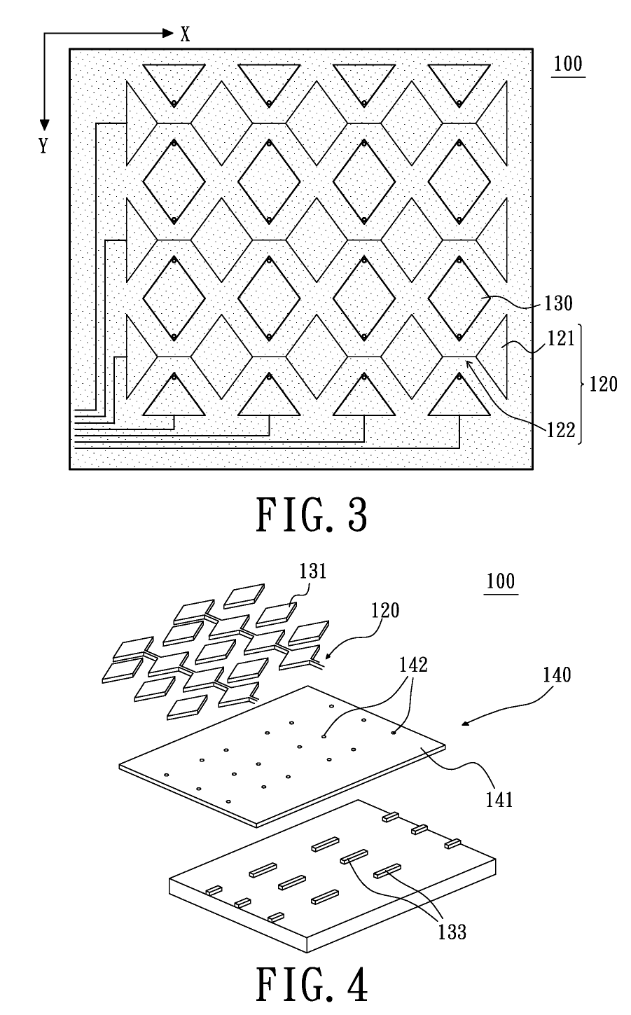

Referring to FIG. 2 and FIG. 3, a touch panel device according to a first embodiment of the present invention is shown. The touch panel device 100 includes a substrate 110, at least one first electrode group 120, at least one second electrode group 130, an insulating layer 140, and an anti-scratch layer 150.

In this embodiment, the touch panel device 100 includes a plurality of first electrode groups 120 and a plurality of second electrode groups 130. The first electrode groups 120 and the second electrode groups 130 are disposed at a same side of the substrate 110. The insulating layer 140 is formed on a surface of the substrate 110. The anti-scratch layer 150 covers the first electrode groups 120 and the second electrode groups 130 for protecting them. In addition, an anti-reflection layer or other protecting layer can be formed on the anti-reflection layer 150.

Each of the first electrode groups 120 includes a plurality of first electrodes 121 and a plurality of first connecting lines 122. The first electrodes 121 are spaced arranged along a straight line. Two adjacent first electrodes 121 are electrically connected via the first connecting lines 122. Referring to FIG. 3, the first electrodes 121 are diamond shapes. Two adjacent corners corresponding to short diagonal respectively belong to two adjacent diamond shaped first electrodes 121 are electrically connected via the first connecting line 122 such that the first electrodes 121 are arranged in the straight line along a direction of an X axis as shown in FIG. 3. Understandably, the configuration of the second electrodes 131 can also be design to other forms according to actual demand without limitation of the diamond shape in this embodiment.

Referring to FIG. 2 and FIG. 3, each of the second electrode groups 130 includes a plurality of second electrodes 131 and a plurality of bridge connecting line-segments 132. In each second electrode group 130, all the bridge connecting line-segments 132 are called as bridge connecting wire. The second electrodes 131 are spaced arranged along a straight line, and two adjacent second electrodes 131 are electrically connected via a bridge connecting line-segment 132. In this embodiment, the second electrodes 131 are diamond shapes, and two adjacent corners corresponding to long diagonal respectively belong to two adjacent diamond shaped second electrodes 131 are electrically connected via a bridge connecting line-segment 132. Thus the plurality of second electrodes 131 are arranged in the straight line along a direction of a Y axis as shown in FIG. 3. Understandably, the configuration of the second electrodes 131 can also be design to other forms according to actual demand without limitation of the diamond shape in this embodiment.

Also referring to FIG. 2 and FIG. 3, each second electrode group 130 includes a plurality of bridge connecting line-segments 132 respectively connected between two adjacent second electrodes 131. Each bridge connecting line-segment 132 includes a first conductive part 133 and two second conductive parts 134 respectively connected to two ends of the first conductive part 133. In this embodiment, each first conductive part 133 is a connecting line-segment. A length of the connecting line-segment is approximately equal to an interval of two adjacent second electrodes 131. The two ends of the first conductive part 133 are electrically connected to two adjacent second electrodes 131 respectively via the two second conductive parts 134.

Referring to FIG. 4 together, in each second electrode group 130, a plurality of first conductive parts 133 are spaced arranged along a straight line and formed on a surface 111 of the substrate 110. In other words, the first conductive parts 133 cover a part of the surface 111 of the substrate 110. The insulating layer 140 is formed on the surface 111 of the substrate 110 to cover the first conductive parts 133 and a part of the surface 111 without the first conductive parts 133 formed thereon. The insulating layer 140 has a flat insulating surface 141 opposite to the surface 111 of the substrate 110. Due to the flat insulating surface 141 of the insulating layer 140, a process for forming the first electrode groups 120 and the second electrodes 131 of the second electrode groups 130 on the insulating layer 140 is relatively simple.

Furthermore, the insulating layer 140 defines a plurality of through holes 142 therein. Each pair of through holes 142 correspond to two ends of each first conductive part 133. The second conductive parts 134 are formed by filling conductive materials in the through holes 142. Such that one end of the second conductive part 134 is electrically connected to the first conductive part 133 and the other end of the second conductive part 134 forms a conducting pad on the insulating surface 141 of the insulating layer 140. The conducting pads are configured for electrically connecting the second electrodes 131 when the second electrodes 131 are formed on the insulating surface 141 of the insulating layer 140 to cover the conducting pads.

The second electrodes 131 is formed on the insulating surface 141 and positions of the second electrodes 131 correspond with the first conductive parts 133 and the second conductive parts 134 such that two adjacent second electrodes 131 are electrically connected with each other via the corresponding first conductive part 133 and the second conductive parts 134. In further description, the plurality of first conductive parts 133 are arranged on the surface 111 of the substrate 110 according to a predetermined demand. Two second conductive parts 134 are respectively disposed on the two ends of the first conductive part 133. The plurality of second electrodes 131 are formed on the insulating layer 141 corresponding to two ends of the first conductive parts 133 and electrically connected with the first conductive parts 133 via the second conductive parts 134. Thus, the bridge connecting line-segments 132 including the first conductive parts 133 and the second conductive parts 134 are formed in the insulating layer 140. In other words, the second electrodes 131 and the bridge connecting line-segments 132 are located in different layers. That is, the plurality of second electrodes 131 on the insulating surface 141 can be electrically connected to each other by a bridge connecting manner via the bridge connecting line-segments 132 including the first conductive parts 133 and the second conductive parts 134 formed in the insulating layer 140.

Referring back to FIG. 2, since the plurality of first electrodes 121 and the plurality of first connecting lines 122 are also formed on the insulating surface 141 of the insulating layer 140, the first electrode groups 120 and the second electrodes 131 of the second electrode groups 130 are formed on the insulating surface 141 of the insulating layer 140, in another word, are located in a same layer to define a sensing plane corporately.

The first electrode groups 120 arranged in straight lines are paralleled to each other on the insulating surface 141 of the insulating layer 140. The second electrodes 131 of the second electrode groups 130 arranged in straight lines are also paralleled to each other on the insulating surface 141 of the insulating layer 140. The first electrode groups 120 and the second electrode groups 130 are alternately arranged. In this embodiment, the first electrodes 121 arranged in straight lines and the second electrodes 131 arranged in straight lines are alternately arranged to form a matrix. In the matrix formed by the first electrodes 121 and the second electrodes 131, the first electrodes 121 do not cross or overlap with the second electrodes 131 such that the first electrodes 121 and the second electrodes 131 are separated with each other and alternately formed on the insulating surface 141 of the insulating layer 140.

The substrate 110 can be made from transparent materials, such as glass, polymeric methyl methacrylate (PMMA), polyvinylchloride (PVC), polypropylene (PP), polyethylene terephthalate (PET), polyethylene naphtalate (PEN), polycarbonate (PC) or other appropriate transparent materials. The substrate 110 can also be made from opaque materials. The first electrode groups 120 and the second electrode groups 130 can be made from transparent conductive materials such as indium tin oxide (ITO) or other opaque materials. The insulating layer 140 can be made from transparent insulating materials such as silicon dioxide or opaque insulating materials.

In other words, the substrate 110, the first electrode groups 120, the second electrode groups 130 and the insulating layer 140 can all made from transparent materials. In an alternative embodiment of the present invention, the substrate 110, the first electrode groups 120, the second electrode groups 130 and the insulating layer 140 can all made from opaque materials. In a further alternative embodiment of the present invention, the substrate 110, the first electrode groups 120, the second electrodes 131 of the second electrode groups 130 and the insulating layer 140 are made from transparent materials and the bridge connecting line-segments 132 of the second electrode groups 130 are made of an opaque material such as sliver or copper. As long as sizes of the bridge connecting line-segments 132 of the second electrode groups 130 are small enough, the touch panel device 100 can also be employed in a transparent environment. The touch panel device 100 made from transparent materials can be used in different touch devices having touch screen, such as mobile telephones, personal digital assistants (PDA), global position systems (GPS) etc. The touch panel device 100 can also be made from printed circuit board (PCB) or flexible printed circuit (FPC) when it is employed in other applications.

The above described anti-scratch layer 150 covers the first electrode groups 120 and the second electrodes 131 for preventing them from damages from an external force. The anti-scratch layer 150 includes a touch surface 151 configured for being contacted with the finger or other conductive element.

Comparing with the conventional touch panel device, the touch panel device 100 provided in above described embodiment has the following advantages. Firstly, because the first electrode groups 120 and the second electrode groups 130 are closed to the touch surface 151, the sensitivity of the touch panel device 100 are correspondingly increased. Secondly, because the first electrode groups 120 and the second electrodes 131 of the second electrode groups 130 are disposed in the same layer, an even sensitivity can be achieved when the conductive element is closed to or contacted with the touch surface 151. In addition, due to the first electrode groups 120 and the second electrodes 131 of the second electrode groups 130 are disposed in the same layer, the configuration of the touch panel device 100 becomes relatively simple, thus, the manufacturing process of the touch panel device 100 is simplified. Thirdly, because of the existence of the insulating layer 140, the first electrode groups 120 and the second electrodes 131 are far away from a light control module (LCM) which is disposed at another side of the substrate 110 opposite to the insulating layer 140. An interference of a sensing process of the touch panel device 100 generated by the LCM can be depressed. Fourthly, flat surface of the touch panel device 100 is propitious to perform a latter optical adjusting method such as reflecting the light. Lastly, because the bridge connecting line-segments 132 of the second electrode groups 130 are disposed in the insulating layer 140 and the insulating layer 140 includes a flat insulating surface 141, it is easy for the first electrode groups 120 and the second electrodes 131 of the second electrode group 130 to be formed on the insulating surface 141.

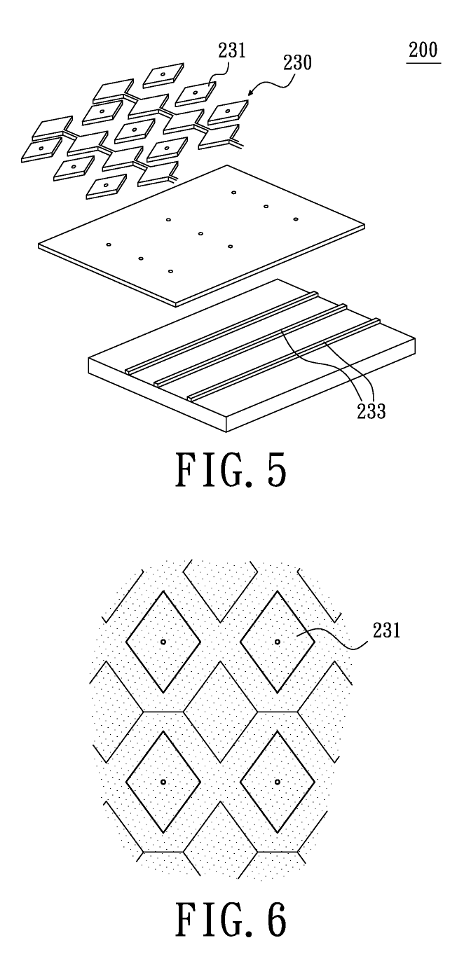

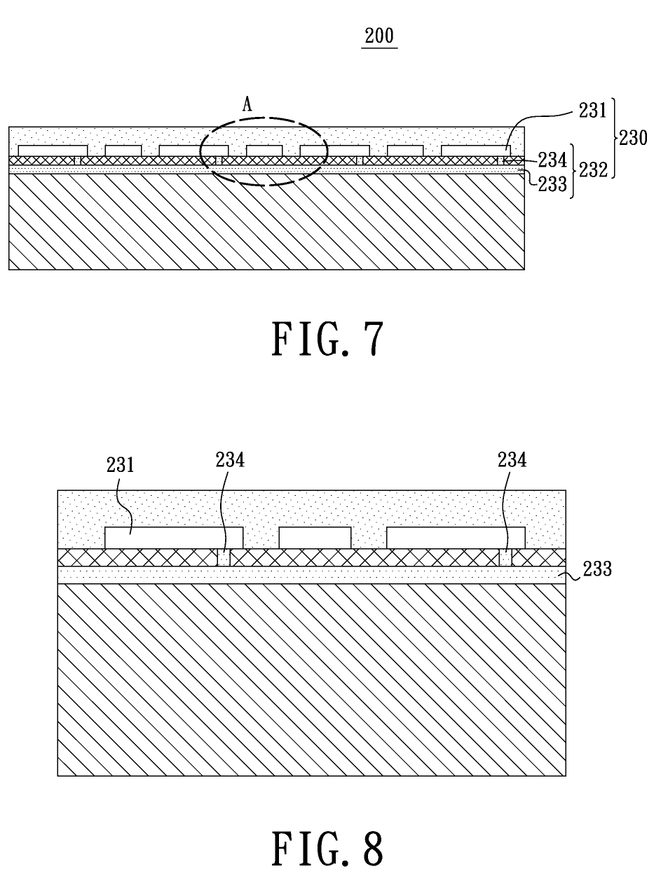

Referring to FIG. 5 to FIG. 8, a touch panel device 200 according to a second embodiment of the present invention is shown. The touch panel device 200 is similar to the touch panel device 100 except for the configurations of second electrode groups 230. The touch panel device 200 includes a plurality of second electrode groups 230. Each second electrode group 230 includes a plurality of second electrodes 231 and a bridge connecting wire 232 for electrically connecting two adjacent second electrodes 231. The bridge connecting wire 232 includes a first conductive part 233 and a plurality of second conductive parts 234 electrically connected to the first conductive part 233. The first conductive part 233 is a line-shaped conducting line corresponding to the plurality of second electrodes 231. The number of the second conductive parts 234 is equal to the number of the second electrodes 231 such that the second conductive parts 234 respectively correspond to the second electrodes 231. Each second electrode 231 is electrically connected to the first conductive part 233 via a corresponding second conductive part 234. Thus the second electrodes 231 are electrically connected in series. In this embodiment, an end of each second conductive part 234 is connected to the first conductive part 233 and the other end of each second conductive part 234 is connected to an end of each second electrode 231.

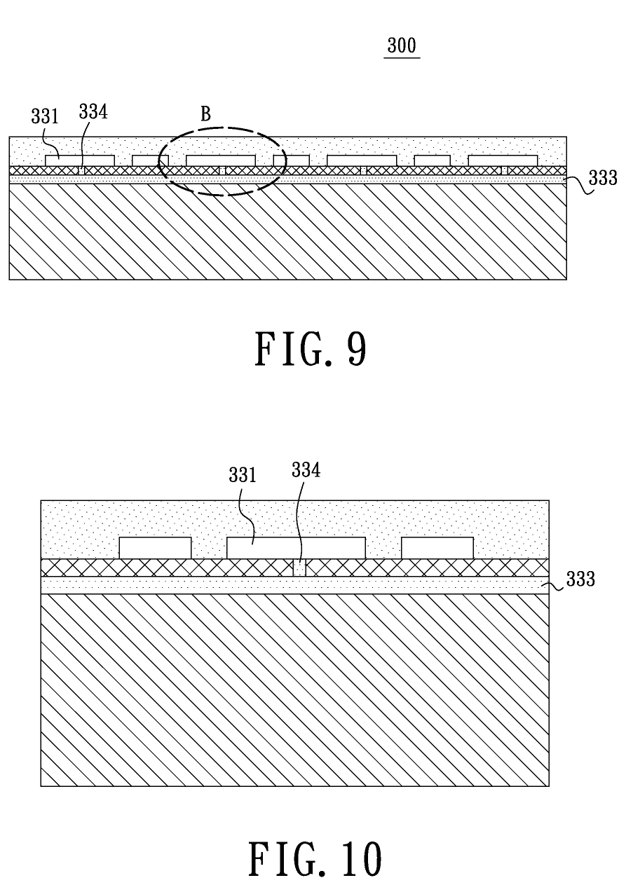

Understandably, the position of connections between the second conductive parts 234 and the second electrodes 231 are not limited to the end of the second electrodes 23 1. In an alternative embodiment of the present invention, the second conductive parts 234 can be electrically connected to any portion of the second electrodes 231. For example, referring to FIG. 9 to FIG. 10, a touch panel device 300 according to a third embodiment of the present invention is similar to the touch panel device 200. A difference therebetween is that an end of each second conductive part 334 is connected to the first conductive part 233 and the other end of each second conductive part 334 is connected to a middle portion of the second electrodes 231.

Comparing with the conventional touch panel device, the touch panel devices 200, 300 have advantages same with that of the touch panel device 100. Furthermore, because the touch panel devices 200, 300 only have one line-shaped first conductive part 233, 333 respectively, which respectively correspond to the plurality of second electrodes 231, 331, a manufacturing process of the touch panel device 200, 300 is further simplified.

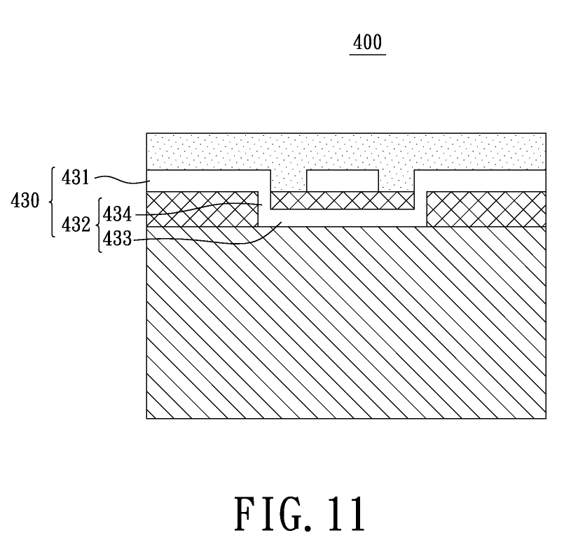

Referring to FIG. 11, a touch panel device 400 according to a fourth embodiment of the present invention is shown. The touch panel device 400 is similar to the touch panel device 100 except for configurations of the second electrode groups 430. The touch panel device includes a plurality of second electrode groups 430. Each second electrode group 430 includes a plurality of second electrodes 431 and a plurality of bridge connecting wires 432. Two adjacent second electrodes 431 are electrically connected to each other via a bridge connecting wires 432. Each bridge connecting wire 432 includes a first conductive part 433 and two second conductive parts 434 respectively connected to two ends of the first conductive part 433. The first conductive part 433 and two second conductive parts 434 are integrated into one body. In this embodiment, the first conductive part 433 and two second conductive parts 434 are integrated into one body to form each U-shaped bridge connecting wire 432.

Comparing with the conventional touch panel device, the touch panel device 400 has advantages same with that of the touch panel device 100. Furthermore, because each bridge connecting wire 432 are integrated into one body by the first conductive part 433 and two second conductive parts 434, a reliability of the electrical conductivity of the bridge connecting wires 432 is increased. Moreover, a process of forming the though holes in the insulating layer and filling the conductive materials in the through holes can be omitted. Therefore, a manufacturing process of the touch panel device 400 is further simplified.

In the above-described embodiments, the elements employed in the first electrode groups and the second electrode groups such as the electrodes, the connecting lines and the first and second conductive parts of the bridge connecting line-segments can be made from same materials such as ITO.

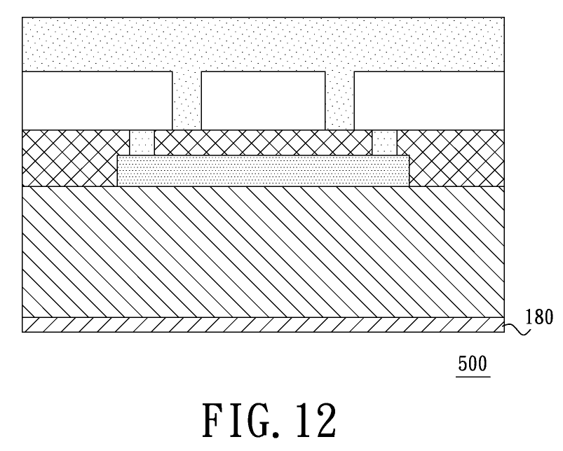

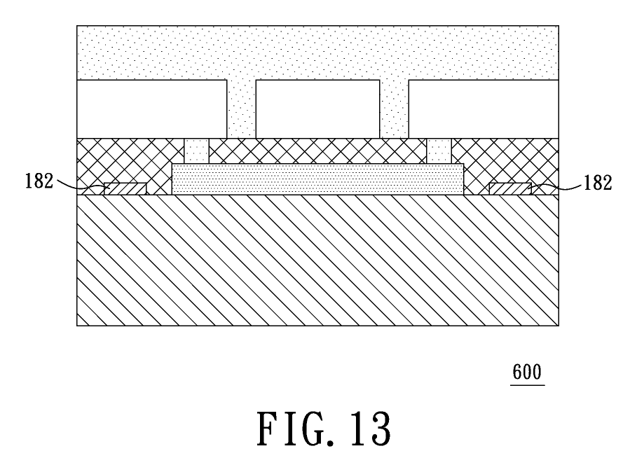

Referring to FIG. 12 and FIG. 13, touch panel devices 500, 600 according to a fifth and a sixth embodiments are respectively shown. The touch panel devices 500, 600 are similar to the touch panel device 100. The touch panel device 500 showing in FIG. 12 further includes a conductive layer 180 on a surface of the substrate opposite to the insulating layer. The touch panel device 600 showing in FIG. 13 further includes a conductive layer 182 formed in the insulating layer 140 adjacent to the bridge connecting line-segments or bridge connecting wires. The conductive layer 180, 182 are configured for shielding interference of the LCM to the sensing electrode of the touch panel devices 500, 600. The conductive layer 180 can also be formed in a net-shape to decrease the capacitance thereof. In an alternative embodiment, the conductive layer 180, 182 can both be employed in a touch panel device. Understandably, such shielding structure can also be applied in other touch panel devices as described above.

To sum up, the configuration of the bridge connecting line of the touch panel devices does not be limited by the illustrated embodiments. The touch panel device can be achieved as long as the first electrode groups and the second electrodes of the second electrode groups are disposed in a same layer or defined a sensing plane corporately, and the bridge connecting line-segments or bridge connecting wires are disposed in a layer different to the sensing plane. In other words, the bridge connecting line-segments or bridge connecting wires are disposed on the substrate and are insulated with the first electrode groups by the insulating layer.

The above description is given by way of example, and not limitation. Given the above disclosure, one skilled in the art could devise variations that are within the scope and spirit of the invention disclosed herein, including configurations ways of the electrodes and materials and/or designs of the electrode. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch panel device comprising:
a substrate;
an insulating layer form on a surface of the substrate;
a plurality of first electrode groups, each first electrode group comprising a plurality of first electrodes and a plurality of first connecting wires each electrically connecting two adjacent first electrodes; and
a plurality of second electrode groups, each second electrode group comprising a plurality of second electrodes and a plurality of bridge connecting wires each electrically connecting two adjacent second electrodes,
wherein the first electrode groups and the second electrodes of the second electrode groups are alternately formed on a surface of the insulating layer away from the substrate, the bridge connecting wires are formed on the surface of the substrate contacting with the insulating layer.

2. The touch panel device as claimed in claim 1, wherein each bridge connecting wire of the second electrode groups comprises a plurality of bridge connecting line-segments, each bridge connecting line-segments comprising a first conductive part and two second conductive parts respectively formed at two end of the first conductive part, each of the two second conductive parts electrically connected to one of the two adjacent second electrodes, respectively.

3. The touch panel device as claimed in claim 1, further comprising a conductive layer formed on the surface of the substrate contacting with the insulating layer and insulating with the second electrode groups.

4. The touch panel device as claimed in claim 1, further comprising a conductive layer formed on a surface of the substrate opposite to the surface contacting with the insulating layer.

5. The touch panel device as claimed in claim 1, wherein each bridge connecting wire comprises a first conductive part and a plurality of second conductive parts, each second conductive part electrically connecting with one of the second electrodes.

6. The touch panel device as claimed in claim 5, wherein each second conductive part is connected to an end of one of the second electrodes.

7. The touch panel device as claimed in claim 5, wherein each second conductive part is connected to a middle portion of one of the second electrodes.

8. The touch panel device as claimed in claim 1, wherein the insulating layer comprises a flat surface for forming the first electrode groups and the second electrodes of the second electrode groups.

9. The touch panel device as claimed in claim 1, wherein the first electrodes of each first electrode group are spaced arranged in a straight line.

10. The touch panel device as claimed in claim 9, wherein the first electrode groups are arranged in parallel.

11. The touch panel device as claimed in claim 10, wherein the second electrodes of each second electrode group are spaced arranged in a straight line and formed on the surface of the insulating layer.

12. The touch panel device as claimed in claim 11, wherein the second electrodes of the second electrode groups are spaced arranged in parallel on the surface of the insulating layer.

13. The touch panel device as claimed in claim 12, wherein the first electrodes and the second electrodes are alternately arranged to form a matrix on the surface of the insulating layer.

14. The touch panel device as claimed in claim 1, wherein the first electrode groups and the second electrodes of the second electrode groups corporately define a sensing plane.

15. The touch panel device as claimed in claim 13, further comprising an anti-scratch layer formed on a surface of the sensing plane.

16. A touch panel device comprising:
a transparent substrate;
a transparent insulating layer form on a surface of the substrate; and
a sensing unit comprising a plurality of first electrode groups and a plurality of second electrode groups, each second electrode group comprising a plurality of electrodes and a bridge connecting wires electrically connecting two adjacent electrodes,
wherein the first electrode groups and the electrodes of the second electrode groups are alternately formed on a surface of the insulating layer to define a sensing plane corporately, the bridge connecting wires are formed between the substrate and the sensing plane.

17. The touch panel device as claimed in claim 16, wherein the bridge connecting wire is formed on the surface of the transparent substrate and covered by the transparent insulating layer.

18. The touch panel device as claimed in claim 16, wherein the surface of the transparent insulating layer with the first electrode groups and the electrodes of the second electrode groups formed thereon is a flat surface.

19. The touch panel device as claimed in claim 16, wherein the bridge connecting wire of the second electrode groups comprises a plurality of bridge connecting line-segments, each bridge connecting line-segment comprising a first conductive part and two second conductive parts formed at two end of the first conductive part, the two second conductive parts electrically connected to two adjacent electrodes, respectively.

20. The touch panel device as claimed in claim 16, further comprising a conductive layer formed on the surface of the transparent substrate contacting with the insulating layer and insulated with the second electrode groups.

21. The touch panel device as claimed in claim 16, further comprising a conductive layer formed on a surface of the substrate opposite to the surface of the substrate contacting with the insulating layer.

22. The touch panel device as claimed in claim 16, wherein the bridge connecting wire comprises a first conductive part and a plurality of second conductive parts each electrically connected to one of the electrodes.
